(19) United States
(12) Patent Application Publication
(10) Pub. No.: US 2017/0182743 A1
(43) Pub. Date: Jun. 29, 2017

(54) OIL SANDS LINER SYSTEM

(71) Applicant: Chemtura Corporation, Middlebury, CT (US)

(72) Inventors: Johnathan Arthur Cribb, Meriden, CT (US); Thomas Harald Peter, Southbury, CT (US)

(21) Appl. No.: 15/384,381

(22) Filed: Dec. 20, 2016

Related U.S. Application Data
(60) Provisional application No. 62/271,761, filed on Dec. 28, 2015.

(51) Int. Cl. B32B 15/092; B32B 1/08; B32B 7/12; B32B 15/18; F16L 58/10; B32B 27/38; B32B 27/40; B05D 1/00; B05D 7/14; B32B 1/02; B32B 27/08

(52) U.S. Cl. CPC B32B 15/092; B32B 1/02; B32B 1/08; B32B 7/12; B32B 15/18; B32B 27/08; B32B 27/38; B32B 27/40; B05D 1/002; B05D 7/146; F16L 58/1009; B32B 2250/03; B32B 2307/536; B32B 2307/584; B32B 2439/02; B32B 2597/00

(57) ABSTRACT

An abrasion resistant multilayer liner for metal substrates with exceptional resistance to delamination, corrosion and physical wear comprises an epoxy layer formed by curing a phenolic epoxy resin with a curative comprising an anhydride adhered or bonded to a surface of the metal substrate, and an elastomeric polyurethane layer adhered or bonded to the epoxy layer. Metal surfaces lined with the inventive liner meet standards established for transport of oil sands slurries.

A liner system for a metal substrate e.g., the surface of steel pipe, which liner system is particularly useful as a liner for the interior surface of a conduit for slurries containing abrasive particles, such as hydrocarbon slurries from oil sands/tar sands operations, said liner comprising a urethane wear layer to give the metal pipe or other metal substrate abrasion resistance and an epoxy barrier layer between the urethane layer and metal substrate, in particular embodiments the interior wall of a steel pipe, wherein the epoxy resin exhibits exceptional adhesion characteristics and resistance to delamination due to cold wall effect.

### BACKGROUND OF THE INVENTION

Mining operations often require the transport of highly abrasive particulate or slurry streams. One example becoming increasingly important in the energy industry is the recovery of bitumen from oil/tar sands. Tar sands are typically extracted from the ground in a slurry containing hydrocarbons, hot water, and particulate sand and rock material with particles up to four inches and greater in diameter. Processing oil/tar sand typically includes transporting and conditioning the oil/tar sand as an aqueous slurry over kilometer lengths of pipe up to one meter or more in diameter at average slurry flow velocities from 2 to 6 m/s. Metal pipes such as carbon steel or cast iron pipes have been used for the transport of these highly abrasive streams of oil sand slurry. However, such pipes are highly susceptible to breakdown due to abrasion from the slurry material.

The equipment used in transport of these slurries is often lined with an abrasion resistant elastomer, e.g., a rubber or polyurethane liner, capable of deflecting the impact energy of the impinging particulates. Rubber-lined steel has become common for pipelines in mining and energy development applications in order to minimize the destruction of pipes due to abrasion. Plastic pipes, other pipe liners and various pipe coatings have also been proposed to minimize the destruction of pipes due to abrasion. However, rubber liners, and many alternatives to rubber liners, will also deteriorate over time due to exposure to heat, hydrocarbons, and particulate matter.

Polyurethane liners offer improved resistance to breakdown due to particulate matter. However, polyurethane liners may exhibit performance drawbacks, including deterioration over time due to high temperatures and permeability to slurry transport fluid, often leading to blistering and disbondment of the liner from the pipe, a failure mode known as “cold wall effect”.

The cold wall effect is a phenomenon that occurs with coatings or liners that have large temperature differentials across them and that are exposed to water or some other highly mobile fluid, generally, where the wall is at a colder temperature than the bulk of the fluid. This temperature difference provides a driving force for fluid migration through the coating. When the coating comes into contact with the fluid, a very small amount of fluid will diffuse through the coating. As a consequence, a small amount of fluid is present at the interface of the coating and the substrate.

The temperature differential across the coating can also cause a change in the fluid density, and in some circumstances when the fluid is water, ice crystals have formed at the substrate. Not wishing to be bound by theory, some combination of fluid pressure, density change, and corrosion of the substrate can cause the coating to pop off of the surface, forming a blister. These blisters can grow over time, leading to complete coating delamination.

The cold wall effect is a significant problem in transport of oil sands slurries, e.g. slurries from Canadian oil sands. Along with being resistant to abrasion, any liner that is employed in oil sands transport must be resistant to delamination due to cold wall effect and corrosion caused by the presence of salt and water. Getting all the properties necessary for a completely successful pipe liner from a single material has proven to be difficult, and multilayer systems have been developed using layers comprising different materials, wherein each layer provides one or more particular advantage. For example, one surface layer of a multilayer structure may provide good adhesion to the metal substrate and a second surface layer may provide good abrasion resistance.

U.S. Patent Application Publications 2009/0107572 and 2009/0107553 describe abrasion resistant ionomer lined steel pipes. U.S. Patent Application Publication 2010/0108173 discloses abrasion resistant polyolefin lined steel pipes. U.S. Patent Application Publication 2010/0059132 describes abrasion resistant pipe liners comprising an abrasion resistant inner layer and a second structural layer comprising extrudable polymer materials. European Patent Application EP 0181233 discloses a method for applying a protective coating to a pipe comprising applying an epoxy coating followed by applying one or more polymeric layers. U.S. Patent Application Publication 2013/0065059 A1 describes a method for bonding ionomer compositions to a metal substrate using an epoxy composition.

DE19602751 discloses a co-extruded three-layer, polyolefin/tie layer/polyurethane film for relining water pipes, wherein the tie layer is an olefin-based polymer adhesive containing maleic anhydride.

U.S. Pat. No. 5,653,555 discloses a process for lining a pipe wherein a lining hose inserted into a pipe and then expanded into contact with the inner diameter of the conduit by inverting a calibration hose.

U.S. Pat. No. 7,320,341 discloses a protective liner for slurry pipelines comprising an abrasion resistant material layer that is adhered to a pipe by an adhesive layer. The abrasion resistant material layer comprises, e.g., a non-woven web material such as nylon. The non-woven web material can comprise a uniform cross-section, open, porous, lofty web having at least one layer, where each layer comprises a multitude of continuous three-dimensionally undulated filaments of high yield strength filament-forming organic thermoplastic material with adjacent filaments being inter-engaged and autogenously bonded where they touch one another.

U.S. Patent Application Publications 2005/0189028 and 20140116518 disclose a liner for tar sand slurries comprising a rubber liner portion, and a polyurethane liner portion disposed on a surface of the rubber liner portion, and a process to line steel pipes using a combination of a rubber adhesive layer to bond the liner to the steel pipe a two-part cast urethane wear layer that is subsequently cross-linked.

Improvements are needed over the liners of the art, especially for pipe liners used in abrasive environments or under conditions likely to cause delamination of the liner, such as environments leading to the cold water effect. In addition to a more robust liner, there is a need for a liner which can be readily applied without using expensive or cumbersome manufacturing processes.

### SUMMARY OF THE INVENTION

The present invention provides an abrasion resistant multilayer liner, also referred to herein as a liner system, for a metal substrate, and a metal substrate to which the abrasion resistant multilayer liner is directly adhered or bonded, wherein the liner comprises an epoxy layer adhered or bonded to a surface of the metal substrate, and an elastomeric polyurethane layer directly adhered or bonded to the epoxy layer, wherein the epoxy layer is formed by curing a phenolic epoxy resin, e.g., an epoxy Novolac resin, with a curative comprising an anhydride, typically a cyclic anhydride.

Also provided is an article, for example a pipe, tank, or part of a pump, comprising a metal substrate to which the multilayer liner is adhered or bonded. In many embodiments, the liner is on an interior metal surface of a pipe, tank, or pump part.

The liner of the invention exhibits high resistance to delamination in harsh environments and is highly effective at protecting the metal substrate from erosion due to abrasion or corrosion. In use, the elastomeric polyurethane layer can act as a wear layer, protecting the epoxy layer and the metal substrate from erosion due to physical contact with fluids and solids, such as impinging particulates as found, e.g., in moving slurries. For example, the elastomeric polyurethane layer of the invention efficiently deflects the impact energy of such impinging particulates, which greatly extends the life of pipes and other materials used in the transport of slurries. The epoxy layer acts as an impervious barrier layer protecting the metal surface from the corrosive effects of water, brine and other liquids.

The epoxy layer of the invention demonstrates excellent adhesion to both the metal substrate being protected and the elastomeric polyurethane layer. Thus, the liner system in its entirety remains adhered or bonded to the metal substrate for prolonged periods of time, even under very hash environmental conditions, such as exposure to temperature changes, moisture and corrosive elements. The liner also performs well in avoiding delamination due to cold wall effect, making the liner ideal for use in pipes and other equipment found in mining and oil extraction. One particular aspect of the invention provides lined metal components, such as lined metal pipes, useful in the transport of slurries, e.g., lines pipes useful in hydrotransport of slurries in the Canadian oils sand fields, comprising the multilayer liner of the invention adhered or bonded to the interior surface, i.e., the surface in contact with the slurry being transported, of the metal pipe or other metal component.

Also provided is a process for preparing the liner of the invention and a process for adhering or bonding the liner to a metal surface, e.g., a process for lining a surface of a metal pipe with the liner of the invention.

### DETAILED DESCRIPTION OF THE INVENTION

The liner of the invention comprises two layers:
an epoxy layer that serves as an impervious barrier layer protecting the underlying metal from corrosion and providing a chemically compatible surface to which an elastomeric polyurethane strongly adheres; and
an elastomeric polyurethane layer that serves as a wear layer, which, for example, prevents particulates, e.g., solids in a slurry, from eroding the underlying steel or impervious barrier layer.

Thus, a lined metal substrate of the invention comprises three layers, the metal substrate, the epoxy layer and the elastomeric polyurethane layer. Other layers can be present, but are not typically necessary, and according to the invention, the epoxy layer lies between and contacts each of the metal substrate and the elastomeric polyurethane layer.

The epoxy layer of the invention is formed from a phenolic epoxy resin, e.g., a Novolac epoxy resin, and a curative comprising an anhydride, typically a cyclic anhydride, for example, a cyclic aliphatic or predominately aliphatic anhydride, such as hexahydrophthalic anhydride. For example, in some embodiments of the invention the cyclic anhydride is a polycyclic compound comprising a cyclic anhydride moiety fused to a 5 to 8 membered monocyclic moiety or a 6 to 14 member polycyclic moiety, wherein the monocyclic or polycyclic moiety comprises at least 4 carbon atoms and optionally one or more oxygen atoms. For example, in some embodiments the cyclic anhydride moiety can be fused to a benzene ring, a naphthyl group, a furan or pyran ring, cyclohexane, cyclopentane, cyclooctane, bicycloheptane, bycyclooctane, etc. The cyclic anhydride compound may also be substituted by alkyl, alkyloxy, halogen, etc. In many embodiments, the mono- or poly-cyclic moiety is either unsubstituted or is substituted by alkyl.

In many embodiments, the cyclic anhydride of the invention is fused to a carbocycle, e.g., a ring wherein each member of the ring is a carbon atom, e.g., in some particular embodiments the cyclic anhydride is phthalic anhydride, trimellitic anhydride, nadic methyl anhydride, tetrahydrophthalic anhydride, methyltetrahydrophthalic anhydride or hexahydrophthalic anhydride. In one particular embodiment, the cyclic anhydride is hexahydrophthalic anhydride.

While not wanting to be bound by theory, it is believed that the excellent resistance to cold wall delamination of the liner system of the invention is largely due to proper selection of the phenolic epoxy resin and the cyclic anhydride containing curative. Excellent resistance to delamination has been achieved using a Novolac epoxy resin and a curative comprising hexahydrophthalic anhydride, when compared to liner systems using the same polyurethane elastomer but a different epoxy curative.

The elastomeric polyurethane of the invention typically has a shore hardness of from 50 A to 100 A, for example, from 60 A to 95 A, or 70 A to 95 A, and in many embodiments from 80 A to 90 A, e.g., 85 A. The polyurethane should exhibit excellent dynamic performance and possess good hydrolytic stability and chemical resistance. The polyurethane is most conveniently prepared by curing an isocyanate capped prepolymer with a curative comprising a polyamine or polyol chain extender. Typical, the chain extenders comprise short chain diols, e.g., a C₂₋₁₂ diol such as butanediol, propanediol, ethylene glycol, hexanediol, or HQEE, or diamines, e.g., MOCA (methylene bis o-chloroananaline), DMTDA (dimethythiotoluenediamine), or MCDEA (methylene bis chlorodiethylanaline). Such curatives may also comprise a mixture of chain extenders such as these with higher MW polyols, e.g., a MW of up to 20,000.

The isocyanate capped prepolymer is made by reacting a polyisocyanate monomer, typically a di-isocyanate, with a polyol, typically a diol, as known in the art. For example, the prepolymer is formed by reacting a molar excess of a diisocyanate, e.g., an aromatic di-isocyanate such as MDI, TDI, PPDI and the like, with a polyether, polyester, polycarbonate, or caprolactone polyol, generally a polyether polyol, such as polyether diol.

Polyether polyols include, e.g., polyalkylene ether polyols having the general formula HO(RO)ₙH, wherein R is an alkylene radical, typically a C₂₋₆ alkylene, and n is an integer large enough to provide the desired MW, e.g., a number average molecular weight of 200 to 20,000, e.g., from 400 to 3000 or from 650 to 2500. Such polyalkylene ether polyols are well-known and can be prepared by the polymerization of cyclic ethers such as alkylene oxides and glycols, dihydroxyethers, and the like. Common polyether diols include, polyethylene ether glycols, polypropylene ether glycols, polytetramethylene ether glycols, mixed ether diols, such as ethylene glycol/propylene glycol ether copolymer diols, end capped polyether diols such as EO-capped polypropylene glycol, and the like.

In order to obtain an elastomer with the desired properties, e.g., hardness, toughness etc., it is important to select the correct pairing of prepolymer with curative. For example, in particular embodiments of the invention, the polyurethane is prepared by reacting a prepolymer prepared from an aromatic di-isocyanate such as MDI, TDI, or PPDI, e.g., MDI or TDI, and a polytetramethylene ether glycol, with a curative. In one particular embodiment, a prepolymer prepared from a MDI and a polytetramethylene ether glycol is reacted with a curative comprising a diol, e.g., butane diol or HQEE, or a curative mixture further comprising a polyalkylenoxy glycol. In some embodiments, a different prepolymer, e.g., one prepared using a different isocyanate and/or polyol is cured with a diamine curative to get the desired elastomer properties. In some embodiments, the prepolymer may be a “low free” diisocyanate prepolymer composition, e.g., a prepolymer composition comprising free diisocyanate levels of less than 10 wt %, less than 5 wt %, less than 3 wt %, less than 1 wt %, or less than 0.5 wt %.

The metal substrate can be of any metallic construction and may be of any shape. In particular embodiments the metal substrate is a pipe, e.g., a steel pipe. The liner may be present on any or all surfaces of the metal substrate, but generally the liner need only be present on the surface that needs protection from impinging particles. For example, in one particular embodiment the substrate is a pipe used in the transport of abrasive slurries, such as those common in oil sand transport, and the liner is adhered or bonded to the interior of the pipe to protect the inner wall from the abrasive effects of the solids, although there is no prohibition against also lining the outside or the pipe. In embodiments such as those related to hydrotransport of oil sand slurries, a further advantage of the inventive liner is that by selecting the proper components for preparation of the polyurethane and epoxy layers, one also protects against delamination of the liner caused by the cold wall effect.

In general, the polyurethane wear layer is thicker than the impervious epoxy barrier layer, and the thickness of each layer, as well as the total thickness of the liner, will depend to a large degree on the shape and use of the metal substrate. For example, when the liner is on the interior of a pipe, a pipe with a larger inner diameter can accommodate a thicker liner than a pipe with a smaller inner diameter, and a pipe transporting softer, smaller or otherwise less abrasive particles may not need as thick a wear layer as pipes used in more demanding applications.

For example, the epoxy layer in general is from 0.01 to 0.25 inches thick, in many embodiments from 0.01 to 0.10 inches thick, for example, from 0.01 or 0.02 to 0.07 to 0.10 inches thick. In some particular embodiments, the epoxy layer is from 0.02 or 0.03 to 0.05 or 0.06 inches thick.

For example, the elastomeric polyurethane layer in general is from 0.25 to 2.5 inches thick, in many embodiments from 0.3 or 0.4 to 1.5 or 2.0 inches thick. In some particular embodiments, the polyurethane layer is from 0.5 or 0.75 to 1.5 to 1.25 inches thick.

For example, one exemplary embodiment of the invention provides a steel pipe with an interior diameter of 20 to 48 inches, e.g., 36 inches, comprising an interior wall to which has been adhered or bonded a 0.02 to 0.06 inch, e.g., 0.04 inch, epoxy layer of the invention, and to which epoxy layer a 0.4 to 1.5 inch, e.g., 1 inch, elastomeric polyurethane payer of the invention is adhered or bonded. Such a pipe is especially suited for use in transporting oil/tar sand slurries, exhibiting excellent resistance to both wear from abrasion, and delamination from the cold water effect. One example of a pipe especially suited for oil/tar sands slurries is a lined steel pipe wherein the epoxy resin is formed by curing an epoxy Novolac resin with a curative comprising an anhydride, typically a cyclic anhydride, such as hexahydrophthalic anhydride, and the elastomeric polyurethane has a shore hardness of from 80 to 95 A, e.g., 85 A, and is formed from an aromatic isocyanate capped polyether polyol, e.g., a PPDI, TDI or MDI capped polyol, such as an MDI/PTMEG prepolymer, which is cured with a curative comprising a polyol such as butane diol, or HQEE, e.g., a curative comprising butanediol. In another example, a suitable pipe may be prepared wherein the polyurethane layer is formed from a TDI capped prepolymer and a curative comprising a diamine.

When used as a liner for a pipe or other metallic substrate that contacts aggressively abrasive or physically damaging materials, such as encountered with oil/tar sand slurries, the excellent dynamic performance of the elastomeric polyurethane layer enables the liner to deflect most of the energy of the incoming slurry particulates while the adhesive properties of the epoxy layer prevent the liner from pulling away from the surface of the metal substrate while also preventing delamination of the polyurethane layer from the surface of the epoxy layer.

The liner system of the invention also offers several ancillary advantages over current liner systems presently used in the Canadian Oil Sands. The use of the epoxy resin greatly reduces the labor cost and time required to produce a lined pipe versus liners that use an impervious rubber layer, as rubber is typically handled as a solid, requiring several people to position and affix the rubber to the inside of the pipe. The epoxy is handled as a liquid which allows for several different methods of application that are relatively easy to automate and allow for rapid application. The urethane used for the wear layer can be selected from a wide array of available urethane systems, allowing the system to be tailored to the specific application needs.

One embodiment of the invention provides a process for forming the inventive multilayer liner on a surface of a metallic substrate. In general, the process comprises applying an epoxy composition comprising the phenolic epoxy resin and cyclic anhydride to a properly prepared metal surface, e.g., cleaned, degreased and dry metal surface; curing or partially curing the epoxy composition; and then casting a urethane curing composition comprising a prepolymer and a curative, e.g., a composition comprising an MDI/polyether prepolymer and a polyol, onto the cured or partially cured epoxy composition, after which the urethane is allowed to cure, typically at elevated temperatures as is common in the art.

Various common steps in preparing the metal surface before applying the epoxy composition include, for example, washing, rinsing with solvent, treating the surface with an abrasive such as sand, grit etc. It is often convenient to heat the phenolic epoxy resin and curative before blending and mixing the two. In many embodiments, the epoxy composition will also contain additional components such as cure accelerators or cure moderators, rheology modifiers, reinforcing agents or other materials known in the art. The epoxy composition can be applied to the metal surface by any suitable method, e.g., film applicator, spray nozzle, etc., and for cylindrical objects such as pipes, the epoxy can be poured onto the surface of the object while is rotated. In many instances, best results are obtained when the liquid epoxy composition is applied to a heated metal surface, e.g., 50 to 130° C. or 70 to 100° C., and the epoxy composition is typically cured at similar temperatures, e.g., 70 to 120° C., or 80 to 100° C.

It is typically necessary to heat the components of the urethane curing composition, e.g., 50 to 80° C., to properly mix and cast the materials. Any appropriate means can be used in mixing the urethane composition and degassing often provides superior results. The urethane is then cast directly onto the epoxy surface, which surface is generally preheated to, e.g., 70 to 120° C. Direct casting may be employed, and in the case of a curved surface, such as a pipe, rotational casting may be used, after which the urethane composition is heated to cure. Cure catalysts may be used in the urethane composition but are not always recommended as the use of some catalysts may cause lower adhesion of the polyurethane layer to the epoxy layer.

For example, a metal surface was lined with the inventive liner system in the following manner: A steel substrate was thoroughly degreased and dried, the surface was then blasted using grit blasting equipment and an appropriate type and size of grit in accordance with NACE SSPC-SP 5 to a profile of 2 mil, after which the surface was rinsed with dry toluene to remove any remaining dust, and after the solvent was evaporated, the prepared surface was immediately coated with the epoxy composition or stored in a dry atmosphere until coated.

An epoxy composition was prepared by heating hexahydrophthalic anhydride, mp 30° C., (70 pphr by wt) under anhydrous conditions to 35° C., which was then added along with benzene dimethylamine (1.75 pphr) to DEN 431 Epoxy Novolac Resin (100 pphr, EEW≈176), which was heated at approximately 50° C. The resulting combination was mixed thoroughly. CAB-O-SIL TS-720 fumed silica (5.15.pphr) was then added as rheology modifier and sag prevention additive and the resulting epoxy composition was mixed using a high shear mixing apparatus.

The prepared metal surface was heated to 80° C. and the epoxy composition was applied and cured at 80° C.-100° C. for 2 hours to prepare an epoxy/metal laminate comprising an epoxy layer on a metal substrate.

A MDI/PTMEG prepolymer with a % NCO≈8.85 was heated to 70° C., degassed and mixed with an appropriate amount of a degassed mixture of 1,4 butane diol and VIBRACURE A122 (2,000 MW polytetramethylene glycol), in a 90:8 mole ratio of butane diol to VIBRACURE A 122, to prepare a urethane curing composition.

The urethane curing composition was then cast directly onto the surface of the epoxy layer of the epoxy/metal laminate, which surface was heated at 100° C. The resulting urethane/epoxy/metal laminate was cured for 30 minutes at 100° C. and then post cured for 16 hours at 100° C. to produce an epoxy/polyurethane lined metal substrate having excellent adhesion between the metal surface and epoxy layer and between the epoxy and polyurethane layers.

Obviously, each of the epoxy layer and polyurethane layer may contain any additive common in the art, e.g., stabilizers, processing aids, fillers etc., provided that the additive is compatible with the end use of the liner and does not interfere with the desired performance of the liner.

Variations on the above exemplary process are of course well within the purview of one skilled in the art and are envisioned within the scope of the present invention.

In order to evaluate whether the inventive liner would be useful in hydrotransport of oil sand slurries, steel substrates were lined with a two layer liner of the invention according to a process similar to that described above, and the resulting lined substrates were tested for adhesion and resistance to cold wall delamination according to rigorous standards developed for testing pipes used in oil sands transport.

For comparison, steel substrates were also lined with comparative two layer liners comprising commercial alternatives to the epoxy impervious barrier layer of the present invention and the same polyurethane layer applied and adhered directly to the alternative barrier layer. The alternative barrier layers included other epoxy resin systems, epoxy/polyurethane hybrid resins systems, and polyurethane resin systems recommended for use as coatings to be directly applied to metal surfaces of pipes for use in demanding transport systems.

Standards for the adhesion of pipe liners used in various operations are available. Syncrude, the largest consortium operating in the Alberta oil sands, has taken the lead in testing the performance of equipment used in hydrotransport of Alberta oil sand slurries. The performance of the liner system of the invention on a steel substrate was tested against other similar liner systems for adhesion in bitumen froth and water aged samples, and for cold wall performance, i.e., Alas cell testing, using test methods as detailed in Syncrude specifications document L-70. According to the standard, each layer of a liner is to be tested for adhesion.

Initial testing evaluated adhesive strength of the impervious barrier layers of the liner system to the steel, and the adhesion of the polyurethane layer to the impervious barrier layer, at room temperature, while hot after aging for 7 days in in 85° C. water, and while hot after aging for 7 days in 85° C. bitumen froth. Adhesion data obtained from the 85° C. bitumen aged samples closely matched the data from the 85° C. water aged samples and are omitted from the present discussion.

It was found in all liner systems tested that the adhesion between the barrier layer and steel was much stronger than the adhesion between the barrier layer and polyurethane layer, and that epoxy barrier layers adhered to the steel more strongly than either polyurethane or epoxy/polyurethane hybrid barriers. Typically, any observed failures occurred at the polyurethane/barrier layer interface. As a result, the more significant data discussed herein relates largely to the adhesion of polyurethane layer to epoxy layer. Table 1 below shows the adhesion strength data obtained before and after aging in water at 85° c. The general composition of the comparative barrier layers is also shown. The comparative barrier layers are commercial materials, some of which contain proprietary components. More details on the tests, measurements and barrier layers are found in the Examples.

TABLE 1
Polyurethane/Barrier Layer Adhesion Results

| | | RT, | 7 Days |
|---|---|---|---|
| Sample | Barrier layer | Unaged | in 85° C. water |
| Comparative Ex 1 | Epoxy Novolac Resin/ | 210 pli | 75 pli |
| | Cycloaliphatic Amine | | |
| Comparative Ex 2 | Bis Phenol A Epoxy/ | 130 pli | No Adhesion |
| | Polyurethane hybrid | | |
| Comparative Ex 3 | Bis Phenol A Epoxy/ | 130 pli | No adhesion |
| | Polyurethane hybrid | | |
| Comparative Ex 4 | Two Component Epoxy | 130 pli | 8 pli |
| Comparative Ex 5 | Modified Urethane | 70 pli | 15 pli |
| Comparative Ex 6 | Modified Urethane | 25 pli | 30 pli |
| Comparative Ex 7 | Ceramic Filled Epoxy | 90 pli | 37 pli |
| | Novolac Resin | | |
| Comparative Ex 8 | Epoxy Novolac Resin/ | 110 pli | 95 pli |
| | Blended Amine | | |
| Comparative Ex 9 | Bis Phenol A Epoxy/ | 80 pli | 45 pli |
| | Amine Curative | | |
| Inventive Ex 1 | Epoxy Novolac/Hexa- | 240 pli | 100 pli |
| | hydrophthalic Anhydride | | |

The Syncrude adhesion specifications require at least 50 pli for unaged room temperature samples and at least 35 pli for 85° C. aged samples.

Good to excellent initial adhesion, i.e. adhesion values in excess of 50 pli from unaged samples at room temperature, were obtained from the inventive Example and most of the comparative Examples. Comparative Examples 2-6 failed to meet the minimum adhesion requirements of greater than 35 pli when measured immediately upon removal from 85° C. water after 7 days of aging. On the other hand, the Inventive Example, Comparative Example 1 and Comparative Example 8, each having epoxy barrier layers, exhibited significantly higher adhesion between the polyurethane and barrier layers after aging in hot water.

The better performing liner systems in the above adhesion testing, Inventive Example 1, Comparative Example 1, and Comparative Example 8, were then evaluated in atlas cell testing, which is designed to measure resistance to delamination due to cold wall effect.

Atlas cell testing attempts to replicate the conditions that bring about the cold wall effect. In the test a sample, i.e., steel plate lined with a test liner system is affixed to the side of a chamber such that one side of the sample. i.e., a side bearing the test liner system, is exposed to a warm test fluid while the other side is exposed to cold air. A temperature differential is maintained across the sample for a period of time, after which the sample is examined for evidence of blister formation or other signs of liner disbondment. The test employed here follows the Syncrude protocol and employs a 17 week period with parameters that are aggressive by industry standards.

Thus, steel plates were lined with the liner systems of the Inventive Example, Comparative Example 1 and Comparative Example 8 and subjected to the Atlas test conditions for 17 weeks. Details of the test can be found on the EXAMPLES section. After 17 weeks of exposure only the liner system of Inventive Example 1 remained fully adhered and passed the Atlas cell criteria. Large blistering was noted with the other liner samples and the liner system of Comparative Example 8 was notable in that after exposure the polyurethane layer was easily pulled off the epoxy barrier surface.

The differences seen in the Atlas cell were dramatic, especially given that the most significant difference between the composition of Inventive Example 1 and Comparative Example 1 is in the curing agent used to cure the epoxy layer.

The above tests demonstrate the surprising superiority of the liner system of the present invention. Epoxy resins or polyurethanes have been used in liners for pipes and polyurethane layers and have found use in many slurry transport operations worldwide. However, as discussed above, existing liners are not sufficiently robust for use in slurry transport pipes exposed to environments found, e.g., in Canadian Oil Sands slurry transport pipes, where both physical wear from impinging particles and the and the cold wall effect due to large temperature differentials play a significant role in pipe failure. Surprisingly, the liner formed from the combination of phenolic epoxy resin cured with a cyclic anhydride and the polyurethane elastomer of the invention exhibited outstanding performance in tests designed explicitly to evaluate liners for use in extremely demanding applications, whereas other similar liners fail.

Consideration of the combination of adhesion and cold wall tests makes clear that the inventive liner system is a far more durable liner for metal substrates exposed to certain demanding environments, and is far more suitable, for example, as a pipe liner for hydrotransport of slurries such as those from oil sand or tar sand fields than other systems.

The multi-layer liner of the invention also offers advantages in the preparation and maintenance of lined steel over pipes lined with an impervious rubber barrier layer bonded to a urethane wear layer presently used in, e.g., the Alberta Oil Sands. For example, the use of an epoxy impervious barrier layer can greatly reduce the labor required to make a lined pipe, as it is much easier to work with the liquid components of the epoxy composition than the solid unvulcanized rubber. The savings in labor cost can be quite substantial. Additionally, systems using rubber layers, preformed barrier liner and other polymer compositions typically require the use of additional adhesives to keep the various layers of the liner in place. Such additional adhesive components are not required in the present epoxy/polyurethane multi-layer liner.

### Examples

### General Procedures:

The liners of the following Inventive and Comparative Examples comprise two polymeric layers adhered to a steel plate or panel, i.e., an impervious barrier layer sandwiched between a steel substrate and an elastomeric polyurethane wear layer. Each impervious barrier layer is a commercially obtained epoxy, epoxy/urethane hybrid, or polyurethane resin system that are said to have good adhesion to metal. In each of the Inventive and Comparative Examples the elastomeric polyurethane wear layer, i.e., outer layer, was an elastomer having a Shore hardness of 85 A prepared by curing VIBRATHANE B836, a commercially available MDI/PTMEG prepolymer having a % NCO≈8.85, with a mixture of 1,4 butane diol and VIBRACURE A122, a PTMEG having a MW≈2000 using standard methods known in the art.

The impervious barrier layer of Inventive Example 1 was prepared by curing Dow DEN 431 epoxy Novolac resin with hexahydrophthalic anhydride in the presence of less than 6 wt % CAB-O-SIL TS-720 fumed silica and a catalytic amount of benzene dimethylamine.

The impervious barrier layers of the Comparative Samples are promoted for use in metal pipes and were prepared using the following commercially obtained materials, and mixed and applied according to recommended procedures:

| | |
|---|---|
| Comparative Example 1 | Dow DEN 431 epoxy Novolac resin/DOW |
| | DEH 4044 cycloaliphatic amine curative |
| Comparative Example 2 | SPC SP-2888 R.G. homopolymerized |
| | bisphenol-A epoxy/urethane resin |
| Comparative Example 3 | SPC SP-3888 bisphenol-A epoxy/urethane resin |
| Comparative Example 4 | SPC SP-1628 bisphenol-A epoxy resin |
| Comparative Example 5 | SPC SP-1386 modified polyurethane resin |
| Comparative Example 6 | SPC SP-1864 modified polyurethane resin |
| Comparative Example 7 | SPC SP-8988 epoxy Novolac resin with |
| | ceramic filler |
| Comparative Example 8 | SPC SP-8888 epoxy Novolac resin/blended |
| | amine curative |
| Comparative Example 9 | 3M SCOTCHKOTE bisphenol-A epoxy resin/ |
| | amine curative |

In the above table SPC stands for Specialty Polymer Coatings, Inc.

Samples for testing were prepared by coating at least a portion of a steel plate with an impervious barrier layer as listed for each example above and then applying the polyurethane wear layer directly to the impervious barrier layer. In the following tests, each of the two layers of the liner system were approximately 0.25 inches thick. The protocol followed for Atlas cell testing calls for using a 0.25 inch thick steel plate. Steel plates of similar thickness were also employed as substrates in the adhesion tests.

Before the impervious barrier layer was applied to the steel substrate, the surface of the substrate was prepared as needed, e.g., degreased, abrasion blasting, cleaning etc., and stored in a dry atmosphere until coating commenced. The components of the impervious layer were mixed immediately prior to application and applied according to the supplier's general recommendations. The elastomeric polyurethane wear layer was prepared by heating the VIBRATHANE B836 MDI/PTMEG prepolymer at 70° C., degassing the prepolymer, mixing in a 90:8 mole ratio of a degassed mixture of 1,4 Butane Diol and VIBRACURE A122 polytetramethylene glycol, and then casting the resulting composition directly onto the surface of the impervious barrier layer, which surface was heated at approximately 100 C. The resulting polyurethane/barrier layer/metal laminate was cured for 30 minutes at 100° C. and then post cured for 16 hours at 100° C.

### Adhesion Testing

The adhesion measurements in these tests are made using a tensile testing unit and a 90° stationary test fixture.

The samples used in these adhesions tests comprise a steel panel, 6 inches long and 25 mm wide, the first 4.5 inches of which is bound to the first 4.5 inches of a 6 inch long liner layer, which liner layer is up to 0.25 inch thick land 25 mm wide. That is, 4.5 inches of the steel panel is bonded to 4.5 inches of the test liner layer while the remaining 1.5 inches of the steel panel is not bonded to the layer. Likewise, the first 4.5 inches of the test liner layer is bound to the steel plate and the remainder of the liner layer is completely non-bonded. This particular arrangement allows for the test strip to be mounted in the stationary test fixture in a manner wherein one end of the test fixture firmly holds the end of the test strip wherein the test layer is bonded to the steel, another end of the test fixture holds the portion of the steel panel not bonded to the test liner layer, and the non-bonded portion of the test liner layer is free to be gripped by the tensile testing unit and pulled away from the test sample at a 90° angle.

As stated above, the protocol calls for testing the adhesion of each layer individually, but the adhesion of the impervious barrier layer to the metal was much stronger then the adhesion of the wear layer to the impervious barrier layer. Further, the more brittle nature of the impervious barrier layer, especially layers comprising cured epoxy resins, made such layers less amendable to attempts at measuring adhesion at a 90° angle to the substrate than the more flexible elastomeric polyurethane wear layers. As a result, the following tests focus on the adhesion of the polyurethane layer to a steel plate already coated with the impervious barrier layer.

Test samples for the present adhesion tests were prepared by coating at least the first 4.5 inches of a 6 inch long steel plate with a layer up to 0.25 inches thick of the impervious barrier layer of each test liner system. The polyurethane composition was then applied to create a polyurethane layer 0.25 inches thick and at least 6 inches long, wherein the first 4.5 inches were bonded to the first 4.5 inches of the impervious barrier layer. The coated plates were then cut lengthwise into strips 25 mm wide, using a water cooled band saw.

The adhesion of unaged samples was tested at room temperature. Test strips were also aged for 7 days in 85° C. water, or for 7 days in 85° C. bitumen froth and the adhesion strength of these aged samples were measured at temperature immediately after removing the samples from the 85° C. water or from the 85° C. bitumen froth. Stress versus strain curves points of failure were reported for each sample. Data for unaged samples and samples aged in 85° C. water are reported in Table 1 above. As stated, the adhesion for samples aged in 85° C. bitumen froth correlated with the samples aged in 85° C. water and are omitted for clarity in making comparisons between the various test liners.

### Atlas Cell Testing

Atlas cell testing attempts to replicate the conditions that bring about the cold wall effect. A sample is affixed to the side of a chamber such that one side of the sample is exposed to a test fluid while the other side is exposed to air. A temperature differential is maintained across the sample for some period of time, often on the scale of a few weeks. After testing, the sample is examined for evidence of blister formation or other signs of liner disbondmant.

Atlas cell testing is a key test that is specified within the Syncrude specification document. The Syncrude version of the test is a 17 week test with parameters that are aggressive, by industry standards. The following details the specifics of the Syncrude version of the atlas cell test.

In the tests, steel plates 6 inches square and 0.25 inches thick were individually coated impervious barrier layers as described above for Inventive Example 1, Comparative Example 1 and Comparative Example 8, upon which a 0.25 inch thick wear layer of the PTMG/MDI elastomeric polyurethane was cast and cured as described above. The lined steel plates were then affixed to one end of an Atlas cell as described below, with liner facing the interior of the cell.

The Atlas cell, once the lined steel plate is in place, is designed to hold water at a specified temperature. Process water, a mixture of water and small amounts of salt, is added to a level that covers approximately 70% of the sample liner such that the remaining 30% is exposed to the headspace of the unit. A heater with an agitator is inserted into the atlas cell and set to maintain the internal temperature to 55° C. with agitation. The entire cell is then placed in a cold chamber set to −15° C., so that the total temperature differential across the sample is 70° C. The sample remains under these conditions for 17 weeks. After 17 weeks, the lined steel test panel is removed and inspected for any signs of blistering or disbondment.

Inventive Example 1 showed no signs of blistering, delamination or disbondmant. Comparative Example 1, and Comparative Example 8, exhibited significant blistering and the liner of Comparative Example 8 was readily pulled off of the epoxy surface with minimal effort.

What is claimed is:

1. An abrasion resistant multilayer liner for a metal substrate, the multilayer liner comprising an epoxy layer obtained by curing a phenolic epoxy resin with a curative comprising an anhydride, and an elastomeric polyurethane layer having a Shore hardness of form 50 A to 100 A, wherein the epoxy layer is adhered or bonded to a surface of the metal substrate, and the elastomeric polyurethane layer is adhered or bonded directly to the epoxy layer.

2. The multilayer liner according to claim 1, wherein the curative comprises a cyclic anhydride.

3. The multilayer liner of according to claim 2, wherein the cyclic anhydride is a polycyclic compound comprising a cyclic anhydride moiety fused to a 5 to 8 membered monocyclic moiety or a 6 to 14 member polycyclic moiety, wherein the monocyclic or polycyclic moiety comprises at least 4 carbon atoms and optionally one or more oxygen atoms.

4. The multilayer liner according to claim 3, wherein the cyclic anhydride comprises phthalic anhydride, trimellitic anhydride, nadic methyl anhydride, tetrahydrophthalic anhydride, methyltetrahydrophthalic anhydride or hexahydrophthalic anhydride.

5. The multilayer liner according to claim 4, wherein the cyclic anhydride comprises hexahydrophthalic anhydride.

6. The multilayer liner according to claim 1, wherein the phenolic epoxy resin is an epoxy Novolac resin.

7. The multilayer liner according to claim 6, wherein the elastomeric polyurethane is prepared by curing an isocyanate capped prepolymer with a curative comprising a polyol, wherein the isocyanate capped prepolymer is prepared by reacting a polyisocyanate monomer with a polyether polyol, polyester polyol, polycarbonate polyol, and/or polycaprolactone polyol.

8. The multilayer liner according to claim 7, wherein the polyisocyanate monomer comprises MDI or TDI.

9. The multilayer liner according to anyone of claim 7, wherein the isocyanate capped prepolymer is prepared by reacting a polyisocyanate monomer with a polyether polyol.

10. The multilayer liner according to claim 9, wherein the polyisocyanate monomer comprises MDI and the polyether polyol comprises a polytetramethylene ether glycol.

11. The multilayer liner according claim 7, wherein the prepolymer comprises less than 3 wt % free diisocyanate monomer.

12. A method for applying an abrasion resistant liner to a metal substrate, which liner comprises an epoxy layer and an elastomeric polyurethane layer having a Shore hardness of from 50 to 100 A, which method comprises applying directly to a surface of the metal substrate an epoxy composition comprising a phenolic epoxy resin and a curative comprising an anhydride and curing or partially curing the epoxy composition at temperatures of 50 to 150° C. to obtain an epoxy layer, and then casting directly onto the epoxy layer an elastomeric polyurethane composition comprising an isocyanate capped prepolymer and a curative comprising a polyol, which polyurethane composition is selected to provide an elastomer having a Shore hardness of from 50 A to 100 A, and then curing the polyurethane composition at temperatures of from 50 to 100° C. to obtain an elastomeric polyurethane layer which is adhered or bonded directly to the epoxy layer.

13. The method according to claim 12, wherein the anhydride is a cyclic anhydride.

14. The method according to claim 12, wherein the phenolic epoxy resin is an epoxy Novolac resin.

15. A lined metal substrate comprising a metal substrate to which is adhered or bonded an abrasion resistant multilayer liner according to claim 1.

16. The lined metal substrate according to claim 16, wherein the metal substrate is a steel substrate.

17. A pipe, tank, or part of a pump comprising the lined metal substrate according to claim 15.

18. A pipe, tank or part of a pump comprising the lined metal substrate according to claim 16 which is used in the transport of mining slurries or oil sand slurries and wherein the liner is adhered or bonded to an interior metal surface of the pipe, tank, or pump part and contacts the mining slurries or oil sand slurries being transported.

19. The abrasion resistant multilayer liner according to claim 1, comprising an epoxy layer having a thickness of from 0.001 to 0.25 inches obtained by curing a phenolic epoxy resin with a curative comprising a cyclic anhydride, and an elastomeric polyurethane layer having a thickness of from 0.25 to 2.5 inches and a Shore hardness of form 50 A to 100 A, wherein the epoxy layer is adhered or bonded to a surface of a metal substrate, and the elastomeric polyurethane layer is adhered or bonded directly to the epoxy layer.
